(19) United States
(12) Patent Application Publication
(10) Pub. No.: US 2007/0127914 A1
(43) Pub. Date: Jun. 7, 2007

(54) Aperture and method for making the same

(75) Inventor: Jen-Tsorng Chang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/479,507

(22) Filed: Jun. 30, 2006

(30) Foreign Application Priority Data
Dec. 2, 2005 (CN) 200510102000.3

(51) Int. Cl. G03B 9/02

(52) U.S. Cl. 396/505

(57) ABSTRACT

An aperture (10) includes a base (12), at least one film (14) and an opaque layer (16). The at least one film is formed on the base for filtering out predetermined wavelengths of light from incoming light. The opaque layer covers the base, and has a light-permeable area (162). The light-permeable area is in light communication with the base and the at least one film. The aperture may not only control the quantity of incoming light, but also filter out infrared light from incoming light. Therefore, the volume of the digital camera is decreased.

### TECHNICAL FIELD

The present invention relates generally to apertures, and more particularly, to an aperture and a manufacture method thereof, which blocks infrared light while allowing propagation of visible light of incoming light.

### BACKGROUND

With the development of wireless communication technologies, increasing numbers of mobile phones and personal digital assistants (PDAs) now include digital cameras as a special feature.

Generally, digital cameras are image recording media capable of photographing a plurality of still images without using film. Such a digital camera typically uses an image sensor, which is a kind of semiconductor device, such as a charged coupled device (CCD) or complementary metal oxide semiconductor (CMOS). The CCD or CMOS may detect the range of 350 nm-1500 nm of the light spectrum. The human visible light spectrum is between 400 nm to 700 nm, and the infrared spectrum is above 700 nm. This means the CCD or CMOS not only detects the visible light, but also detects part of the infrared light spectrum. The infrared light may contaminate the image sensor, and degrade the image quality.

In order to solve the above problem, an infrared-cut (IR-Cut) filter is typically used in conjunction with an image sensor in a digital camera. The IR-Cut filter prevents or limits infrared radiation from reaching the image sensor. In addition, the digital camera also needs an aperture to control the quantity of incoming light. Therefore, the IR-cut filter and aperture are necessary for the digital camera. However, the IR-cut filter and the aperture have some thickness. When the two elements are arranged, the thickness of the entire digital camera is increased. This increased thickness makes them unsatisfactory for use in compact digital cameras.

Therefore, an aperture and a method for making the aperture are desired in order to overcome the above-described shortcomings.

### SUMMARY

In one aspect, an aperture includes a base, at least one film and an opaque layer. The at least one film is formed on the base for filtering out predetermined wavelengths of light from incoming light. The opaque layer is formed on the base, and has a light-permeable area. The light-permeable area is in light communication with the base and the at least one film.

In another aspect, a method for making an aperture includes the steps of: providing a substrate; applying at least one film onto the substrate, the at least one film filtering out predetermined wavelengths of light; applying an opaque layer onto one of the at least one film and the substrate; forming a plurality of light-permeable areas on the opaque layer so as to control the amount of light; and cutting the substrate to create single apertures each having one of the light-permeable areas.

Other advantages and novel features will become more apparent from the following detailed description when taken in conjunction with the accompanying drawings.

### BRIEF DESCRIPTION OF THE DRAWINGS

Many aspects of the aperture can be better understood with reference to the following drawings. The components in the drawings are not necessarily drawn to scale, the emphasis instead being placed upon clearly illustrating the principles of the aperture. Moreover, in the drawings, like reference numerals designate corresponding parts throughout the several views.

FIG. 1 is an isometric view of an embodiment of an aperture;

FIG. 2 is an isometric view of a substrate for manufacturing the aperture of FIG. 1;

FIG. 3 is an isometric view of FIG. 2 after the substrate is coated with a film;

FIG. 4 is an isometric view of FIG. 3 after the substrate is coated with an opaque layer;

FIG. 5 is an isometric view of FIG. 4 after exposure;

FIG. 6 is a cross-sectional view of FIG. 5 along line VI-VI;

FIG. 7 is a cross sectional view of FIG. 5 along line VII-VII; and

FIG. 8 is a schematic view showing the substrate being punched by a puncher.

### DETAILED DESCRIPTION OF THE EMBODIMENTS

Referring now to the drawings, FIG. 1 shows a fixed aperture 10, according to a preferred embodiment. The aperture 10 is adapted for use in a digital camera, but its compact nature could also prove useful in compact digital camera units or digital camcorders. The aperture 10 includes a base 12, a film 14 and an opaque layer 16.

The base (i.e., substrate) 12 is substantially disk-shaped, and may be made of high transmission light glass material such as B270 or BK7. B270 and BK7 are commercially available glasses obtainable from Schott Company in German. Alternatively, the base 12 may be transparent plastic material such as polycarbonate (PC), cyclo-olefin copolymer (COC) or cyclo-olefin polymer (COP) or the like.

The film 14 is formed on the base 12 by means of multi-coating technology. The film 14 may filter out infrared light from incoming light so as to improve the image quality.

The opaque layer 16 covers a periphery of the film 14, thereby forming a light-permeable area 162 on a middle area of the film 14. The light-permeable area 162 is in light communication with the base 12 and the film 14. The opaque layer 16 is made of an opaque material. The light-permeable area 162 is substantially circular in shape, and a diameter of the light-permeable area 162 may be adjusted so as to control the amount of light passing through the aperture 10. As such, the aperture 10 may not only filter out infrared light from incoming light, but also control the quantity of incoming light. Therefore, the image quality is improved, and the volume of the digital camera is decreased.

A method for fabricating the aperture 10 is disclosed by way of example. In one embodiment, a plurality of apertures 10 are fabricated simultaneously to minimize the cost associated with each individual aperture 10.

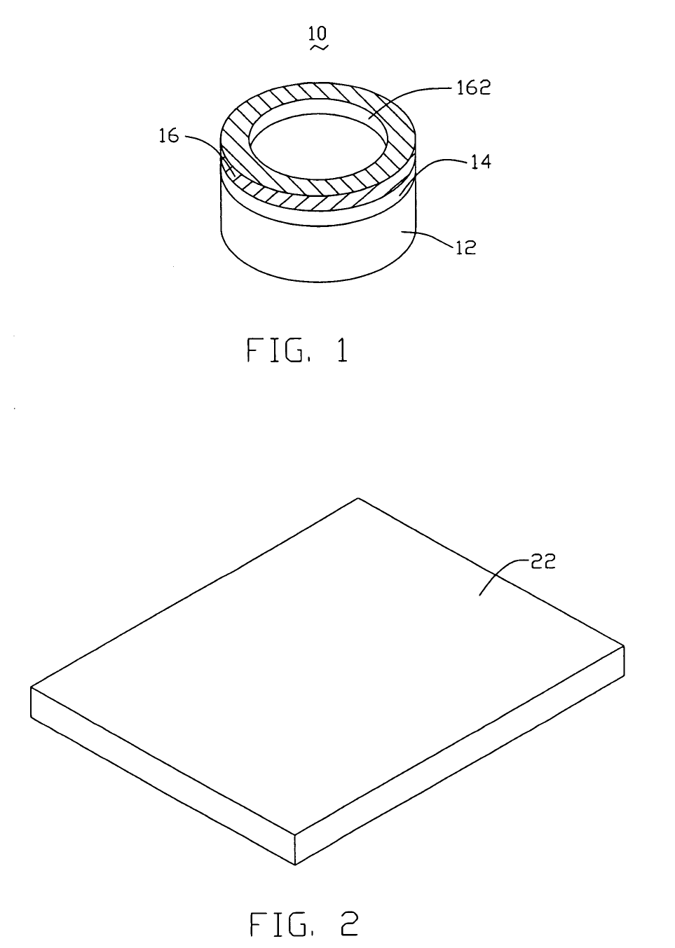

Referring to FIG. 2, at first, a substrate 22 is provided. The substrate 22 is substantially a rectangular board. The substrate 22 is made of transparent glass material or plastic material with capable of high levels of light transmission. If the glass material is chosen, it might be B270 or BK7. If the plastics material is chosen, it might be PC, COC, COP or the like.

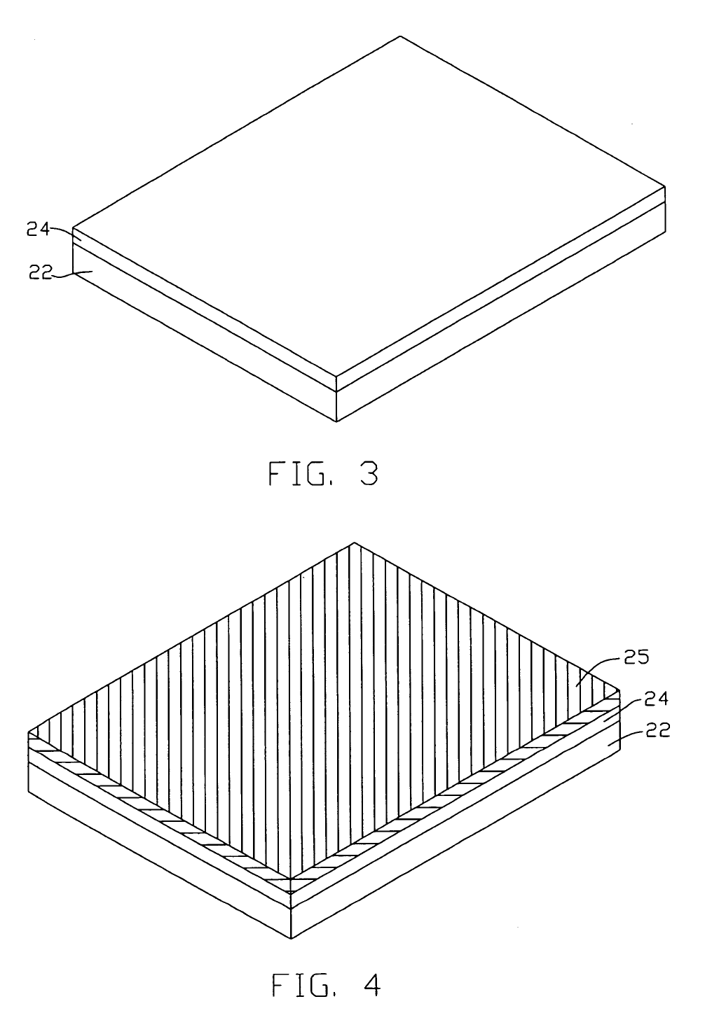

Referring to FIG. 3, the substrate 22 may be coated with an IR-Cut film or other such filtering predetermined wavelengths of light film by evaporation deposition process, thereby forming a film 24.

Then, referring to FIG. 4, an opaque photoresist or silver halide material coating may completely cover the film 24, being applied using a method such as spin-coating, thereby forming an opaque layer 26.

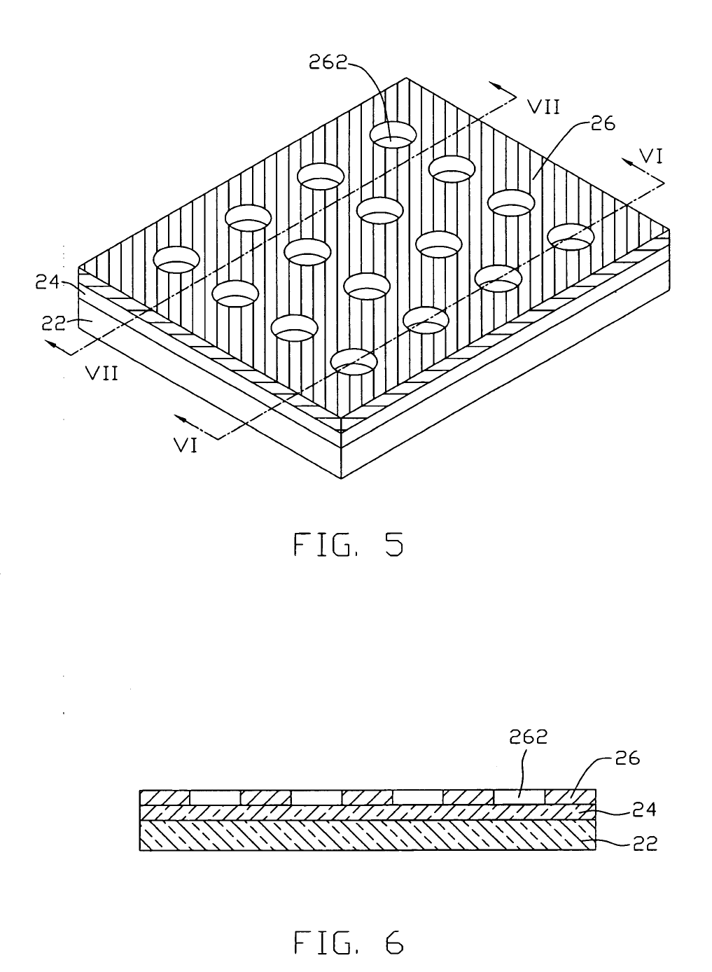

Referring to FIGS. 5 and 6, a plurality of light-permeable areas 262 are formed on the opaque layer 26. An exemplary method of forming the light-permeable areas 262 includes so called “exposure photolithography”. In this method, a photo mask with a plurality of spaced holes covers the substrate 22 so as to expose some regions of the opaque layer 26. When light shines through the holes of the photo mask, the exposed photoresist or silver halide material undergoes chemical reaction. This causes the exposed regions of the opaque layer 26 to be removed. The light-permeable areas 262 are arranged in a set of arrays. Accordingly, the substrate 22 forms a plurality of apertures 10 connected to each other as a result.

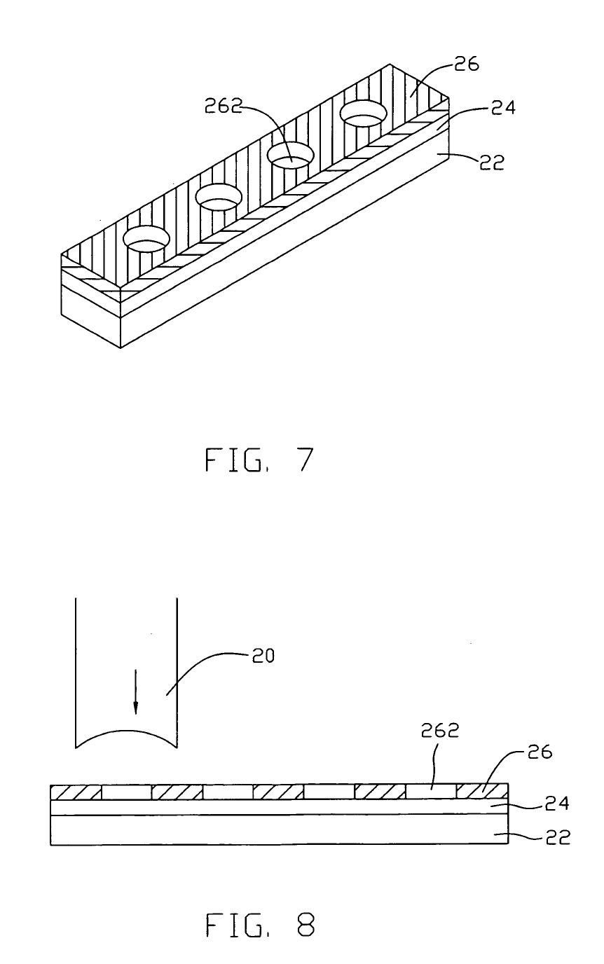

After that, the substrate 22 can be cut into a plurality of single apertures 10. Referring to FIG. 7, the substrate 22 may be cut to be a strip configuration. The strip configuration makes the apertures 10 convenient to move.

Finally, referring to FIG. 8, the strip substrate 22 is punched by a puncher 20 so as to form single apertures 10 each having one of the light-permeable areas 262. Alternatively, the substrate 22 may be cut to be a plurality of square configurations. Then, the square apertures can be made circular by grinding process. Thus, the aperture 10 is obtained.

A main advantage of the method is that the aperture may be made with a very small hole, and is very suitable for manufacturing a small aperture. Moreover, the light-permeable areas may effectively avoid coarse edges through this method. Furthermore, a discrete filter may be omitted. Accordingly, the costs are decreased, and the volume of the digital camera can be reduced in size as a result.

In alternative embodiments, the opaque layer 16 may be formed on an opposite side of the film 14.

In another alternative embodiment, the film 14 may be formed on the light-permeable area 162 only so as to filter out infrared light from incoming light.

In other alternative embodiments, the method of coating the opaque layer 26 may only cover the periphery of the substrate 22.

As described above, the preferred embodiment provides an aperture 10 for devices such as digital camera, mobile phones, which may not only filter out infrared light from incoming light, but also control the quantity of incoming light. It is, however, to be understood that the aperture 10 could potentially be useful in other applications in which it may be desirable to allow incoming light to be adjusted so as to attain a clear image.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An aperture for a camera module, comprising:
a base;
at least one film forming on the base, the at least one film being configured for filtering out predetermined wavelengths of light from incoming light; and
an opaque layer formed on the base, the opaque layer having a light-permeable area, the light-permeable area being in light communication with the base and the at least one film.

2. The aperture as claimed in claim 1, wherein the base is made of glass material or a plastic material.

3. The aperture as claimed in claim 2, wherein the glass material of the base is B270 or BK7.

4. The aperture as claimed in claim 2, wherein the plastics material of the base is polycarbonate, cyclo-olefin copolymer or cyclo-olefin polymer.

5. The aperture as claimed in claim 1, wherein the at least one film is an infrared-cut film.

6. The aperture as claimed in claim 1, wherein the opaque layer is made of an opaque photoresist or silver halide material.

7. The aperture as claimed in claim 1, wherein the opaque layer is formed on a periphery of the at least one film.

8. The aperture as claimed in claim 1, wherein the opaque layer is formed on one side of the base, and the at least one film is formed on the other side of the base.

9. An aperture, comprising:
a substrate;
a film formed on the substrate, the film being configured for filtering out predetermined wavelengths of light from incoming light; and
an opaque layer formed on the film, the opaque layer having a light-permeable area, the light-permeable area being configured for allowing the incoming light to pass through the film and the filtered incoming light to pass through the substrate.

10. The aperture as claimed in claim 9, wherein the opaque layer is made of an opaque photoresist or silver halide material.

11. The aperture as claimed in claim 9, wherein the opaque layer is formed on a periphery of the film.

12. The aperture as claimed in claim 9, wherein the film is an infrared-cut film.

13. A method for manufacturing an aperture, comprising the steps of:
providing a substrate;
applying at least one film onto the substrate, the at least one film filtering predetermined wavelengths of light;
applying an opaque layer onto one of the at least one film and the substrate;
forming a plurality of light-permeable areas on the opaque layer so as to control the amount of light; and
cutting the substrate to create single apertures each having one of the light-permeable areas.

14. The method as claimed in claim 13, wherein the at least one film is applied using evaporation deposition process.

15. The method as claimed in claim 13, wherein the opaque layer is applied using a spin-coating process.

16. The method as claimed in claim 14, wherein the light-permeable areas are formed using an exposure photolithography method.
